(19) United States
(12) Patent Application Publication
(10) Pub. No.: US 2025/0077120 A1
(43) Pub. Date: Mar. 6, 2025

(54) CONTROLLER AND MEMORY SYSTEM

(71) Applicant: Kioxia Corporation, Tokyo (JP)

(72) Inventors: Yoshihiro OHBA, Kawasaki Kanagawa (JP); Tomoya SANUKI, Yokkaichi Mie (JP)

(73) Assignee: Kioxia Corporation, Tokyo (JP)

(21) Appl. No.: 18/805,746

(22) Filed: Aug. 15, 2024

(30) Foreign Application Priority Data
Sep. 4, 2023 (JP) 2023-143100

(51) Int. Cl. G06F 3/06

(52) U.S. Cl. CPC G06F 3/0659; G06F 3/0623; G06F 3/0679

(57) ABSTRACT

According to one embodiment, a controller includes a first interface configured to receive an I/O command specifying first host data from a host, a second interface configured to transmit and receive the first host data to and from a storage, and a computation processing circuit. The computation processing circuit includes an input circuit configured to input the first host data and plural computation parameters, a duplication processing circuit configured to obtain plural first host data by duplicating the first host data, plural first processing circuits configured to execute computation processes using the input plural parameters for the obtained plural first host data, and an output circuit configured to output computation results.

### CROSS-REFERENCE TO RELATED APPLICATIONS

This application is based upon and claims the benefit of priority from Japanese Patent Application No. 2023-143100, filed Sep. 4, 2023, the entire contents of which are incorporated herein by reference.

### FIELD

Embodiments described herein relate generally to a controller and a memory system.

### BACKGROUND

In recent years, storage devices with functions of processing computation instructions on behalf of the host (hereinafter referred to as a computing storage devices) have been developed.

In such computing storage devices, when a computing storage I/O command (hereinafter referred to as an I/O command) sent from the host is received, the computation instruction is processed according to computation options associated with the I/O command, and the host data (for example, read data) specified by the I/O command can be thereby replaced with a result of the processing (computation result).

Incidentally, when the computation instruction is processed as described above, computation processing on host data (input data) may be executed using computation parameters, but the computation process takes a lot of time in a case of executing, for example, secure computation (multiparty computation) using fully homomorphic encryption.

### BRIEF DESCRIPTION OF THE DRAWINGS

FIG. 1 is a block diagram showing a configuration example of a computing storage device according to an embodiment.

FIG. 2 is a table illustrating a data structure of a virtual register table according to the embodiment.

FIG. 3 is a diagram schematically showing a virtual address space in the embodiment.

FIG. 4 is a flowchart showing an example of a procedure of an accelerator operating in CwR mode in the embodiment.

FIG. 5 is a diagram showing an example of a data structure of a page table in the embodiment.

FIG. 6 is a flowchart showing an example of a paging algorithm in the embodiment.

FIG. 7 is a flowchart showing an example of a procedure of an accelerator operating in CwW mode in the embodiment.

FIG. 8 is a flowchart showing an example of a procedure of an accelerator operating in CoR mode in the embodiment.

FIG. 9 is a flowchart showing an example of a procedure of an accelerator operating in CoW mode in the embodiment.

FIG. 10 is a diagram showing an example of a configuration of a computation processing circuit provided in the accelerator according to the embodiment.

FIG. 11 is a diagram showing another example of the configuration of the computation processing circuit provided in the accelerator according to the embodiment.

FIG. 12 is a diagram showing yet another example of the configuration of the computation processing circuit provided in the accelerator according to the embodiment.

FIG. 13 is a table illustrating an example of a virtual register number computation method in the embodiment.

FIG. 14 is a table showing an example of an instruction set of secure computation instructions used by the accelerator according to the embodiment.

FIG. 15 is a table showing an example of a secure computation program stored in a program register in the embodiment.

FIG. 16 is a table showing an example of the secure computation program further executed in the embodiment.

FIG. 17 is a table showing an example of the secure computation program further executed in the embodiment.

FIG. 18 is a table showing an example of the secure computation program further executed in the embodiment.

FIG. 19 is a table showing another example of a secure computation program stored in a program register in the embodiment.

FIG. 20 is a diagram illustrating a configuration of a computing storage device that executes communication with a host based on the NVMe standard in the embodiment.

FIG. 21 is a diagram illustrating a configuration in which an accelerator according to the embodiment is arranged inside an SSD controller.

FIG. 22 is a diagram illustrating a configuration in which the accelerator according to the embodiment is arranged inside an NVMe-oF target module.

### DETAILED DESCRIPTION

In general, according to one embodiment, a controller is configured to control a computing storage device including a storage connectible to a host. The controller includes a first interface configured to receive an I/O command specifying first host data from the host, a second interface configured to transmit and receive the first host data to and from the storage, and a computation processing circuit. The computation processing circuit includes an input circuit configured to input the first host data and plural computation parameters, a duplication processing circuit configured to obtain plural first host data by duplicating the first host data, plural first processing circuits configured to execute in parallel computation processes using the input plural parameters for the obtained plural first host data, and an output circuit configured to output computation results of the plural first processing circuits.

Embodiments will be described hereinafter with reference to the accompanying drawings.

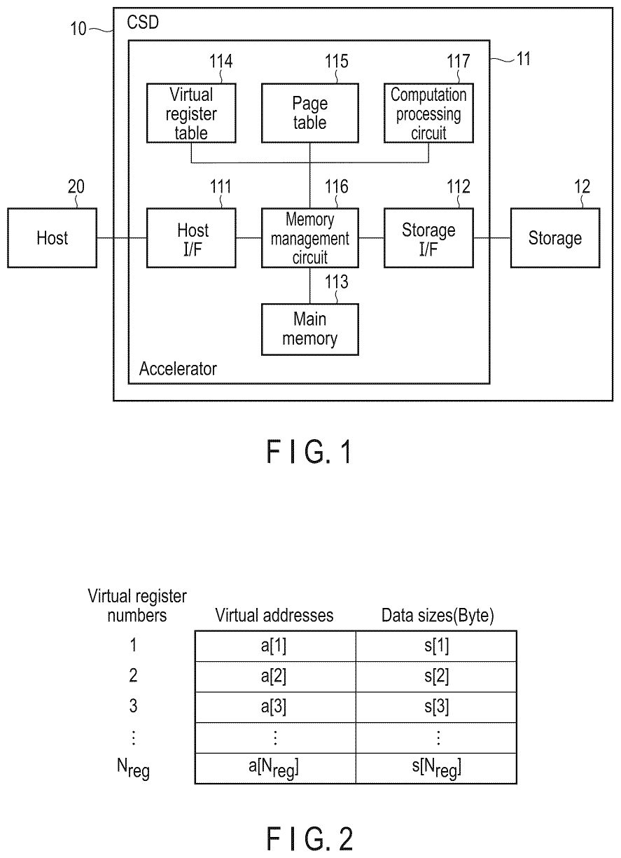

FIG. 1 is a block diagram showing a configuration example of a computing storage device (hereinafter referred to as CSD) according to an embodiment. The CSD 10 shown in FIG. 1 corresponds to, for example, a storage device including a function of processing computation instructions and is also referred to as a memory system.

The CSD 10 is configured to be connectible to a host 20 and includes an accelerator 11 and a storage 12.

The accelerator 11 is a device operating to increase the processing speed of the computer system (CSD 10 and host 20) and corresponds to a controller that controls the CSD 10. The accelerator 11 is realized by, for example, various circuits, and the like. As shown in FIG. 1, the accelerator 11 includes a host interface (I/F) 111, a storage interface (I/F) 112, a main memory 113, a virtual register table 114, a page table 115, a memory management circuit 116, and a computation processing circuit 117.

The host interface 111 receives computing storage I/O commands (hereinafter referred to as I/O commands) specifying host data from the host 20. The I/O commands include read commands to read data from the storage 12 and write data to write data to the storage 12. The host data specified by the I/O commands includes the read data to be read from the storage 12 and the write data to be written to the storage 12 based on the I/O commands (read commands and write commands). With the I/O commands, the host data is specified by the logical address used to access the storage 12 (i.e., to read data from the storage 12 and to write data to the storage 12). The host interface 111 transmits and receives the host data to and from the host 20.

The storage interface 112 transmits and receives the host data to and from the storage 12. In other words, when the host data is the read data, the storage interface 112 receives the read data from the storage 12. In addition, when the host data is the write data, the storage interface 112 transmits the write data to the storage 12.

The main memory 113 is used to store a copy of the host data (data to be read/written by the I/O commands) specified by the I/O commands. The main memory 113 is configured to be accessible at a faster speed than the storage 12 and is realized by, for example, a memory such as DRAM (not shown) provided in the CSD 10.

The virtual register table 114 is a table for managing virtual registers that hold data used to process the computation instructions according to computation options associated with the host data specified by the I/O commands. More specifically, the virtual register table 114 stores a virtual address indicated by a page number and a page offset assigned to a page where the data used to process the computation instructions according to the computation options are stored, and the data size of the data, in association with respective virtual register numbers specified (computed) based on the computation options.

The page table 115 is a table for managing the main memory 113 or the storage 12 (i.e., a swap area to be described below) as a storage destination of the data on the page, for each of the page numbers. More specifically, the page table 115 stores a flag indicative of the data storage destination (hereinafter referred to as a storage destination flag) and an actual address of the storage destination (hereinafter referred to as a storage destination actual address), in association with each page number.

The memory management circuit 116 executes processes of storing a copy of the host data specified by the I/O command in the main memory 113 by referring to the page table 115 and updating the virtual register table 114, depending on the operation mode of the CSD 10, which will be described later.

The computation processing circuit 117 processes computation instructions according to the computation options associated with the host data specified by the I/O commands (i.e., computation instructions using the host data) by referring to the virtual register table 114.

A data structure of the above-described virtual register table 114 shown in FIG. 1 (i.e., virtual registers managed in the virtual register table 114) will be described with reference to FIG. 2.

The virtual register table 114 stores virtual addresses and data sizes in association with the virtual register numbers as described above. In other words, in the present embodiment, one virtual register is referred to using the virtual register number assigned to the virtual register and is represented by a pair of virtual address and data size.

The virtual address is indicative of a memory area represented by a pair of page number and page offset. The unit of data size is byte. In FIG. 2, it is assumed that the total number of virtual registers managed by the virtual register table 114 is N_{reg}.

By the way, the host data specified in I/O commands received from the host 20 is accompanied by computation options for processing computation instructions. The computation options include a content identifier and a data size (byte). The content identifier is represented by (a pair of) Type, Key ID, and Data ID.

In an example of the structure of the computation option, when a computation option that can be used in Torus Fully Homomorphic Encryption (TFHE), which is one of the secure computation techniques (secure operation technologies) is assumed, Type is the TFHE data type, Key ID is the key number, and Data ID is the TFHE data identifier. For example, Type is represented by a value from 0 to 6, Key ID is represented by a value greater than or equal to 0, and Data ID is represented by a value greater than or equal to 0. Incidentally, the torus in TFHE is a mathematical structure referred to as an algebraic torus or circle group, which is a multiplication group T={z∈C: |z|=1}^{x} defined by a set of unit circular points {z∈C: |z|=1} in the complex plane C and a binary operation “x”. For example, lattice-based cryptography referred to as Torus Learning with Errors (TLWE) is used in the TFHE. TFHE cipher text is referred to as a TLWE sample and is represented as a vector of toruses. In the present embodiment, the torus is assumed to be scaled and encoded as a 32-bit integer value.

The above virtual register number in the virtual register table 114 are computed (specified) from the content identifiers included in such computation options. Incidentally, a method of computing the virtual register numbers based on the content identifiers will be described below.

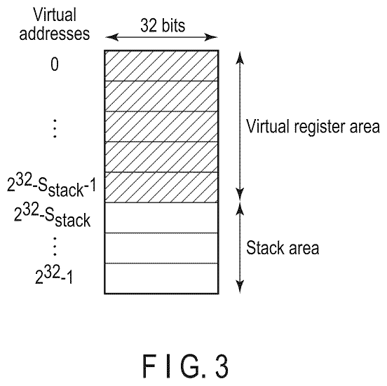

Next, FIG. 3 is a diagram schematically showing the virtual address space in the present embodiment. The virtual address space includes a virtual register area and a stack area.

The virtual register area is, for example, an area corresponding to plural virtual registers including a program register to be described below, and the like. The stack area has a structure that holds a cipher text in Last In Last Out (LILO) format during stack operations using Push instruction and Pop instruction, which are to be described below.

Incidentally, the virtual address is 32 bits in the example shown in FIG. 3. In addition, in FIG. 3, S_{stack} is indicative of the stack size (i.e., size of the stack area) using the unit of bytes. In this case, the maximum value of the virtual address that can be used in the virtual register area is 2³²−S_{stack}−1. In addition, the virtual address of the bottom of the stack area is represented by 2³²−1. In addition, when accessing (the main memory 113 for) the virtual register area and the stack area, the page table 115 is used. Details of the page table 115 will be described below.

A basic operation of the accelerator 11 according to the present embodiment will be described below. The accelerator 11 according to the present embodiment operates in each of Copy with Read (CwR) mode, Copy with Write (CwW) mode, Compute on Read (CoR) mode, and Compute on Write (CoW) mode.

Incidentally, the host data in the present embodiment includes host data attached computation options and host data attached no computation options. In addition, when the computation options are attached to the host data, the computation options are assumed to be included in the metadata attached to the host data.

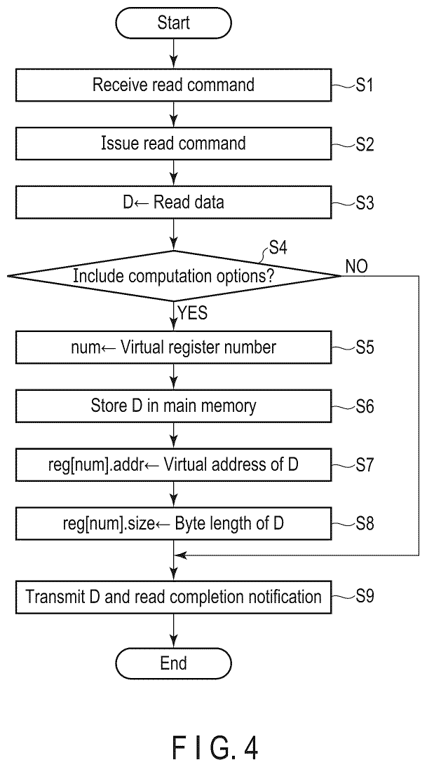

FIG. 4 is a flowchart showing an example of the procedure of the accelerator 11 operating in the CwR mode. The CwR mode is an operation mode for copying the host data (read data) specified by the read command from the host 20 to the main memory 113.

First, the host interface 111 receives the read command (I/O command) from the host 20 (step S1). The read command received in step S1 includes the logical address to be used to access the read data.

Next, the storage interface 112 issues (transmits) the read command received in step S1 to the storage 12 (step S2).

When the process of step S2 is executed, the host data is read from the storage 12, based on the logical address included in the read command. In this case, the memory management circuit 116 receives a read completion notification and the read data corresponding to the read completion notification from the storage 12 via the storage interface 112. The memory management circuit 116 stores the received read data in variable D (step S3).

Next, the memory management circuit 116 determines whether or not the metadata attached to the read data (i.e., variable D) includes a computation option (step S4).

If determining that the metadata attached to the read data includes a computation option (YES in step S4), the memory management circuit 116 stores the virtual register number calculated based on the computation option (content identifier) in variable num (step S5).

Next, the memory management circuit 116 stores the variable D (read data) in a free area of the main memory 113 (step S6).

When the process of step S6 is executed, the memory management circuit 116 set the virtual address indicative of the memory area of the main memory 113 where the variable D is copied, in the virtual register table 114, as a virtual address corresponding to the variable num (i.e., a virtual address referred to by the virtual register number stored in the variable num). In other words, the start virtual address of the copy destination of the variable D is set in the virtual address field (reg [num].addr) of the variable num-th virtual register (step S7).

Furthermore, the memory management circuit 116 sets the data size of the variable D in the virtual register table 114 as the data size corresponding to the variable num (i.e., the data size referred to by the virtual register number stored in the variable num). In other words, the byte length of the variable D is set in the data size field (reg [num].size) of the variable num-th virtual register (step S8).

When the process of step S8 is executed, the memory management circuit 116 transmits the variable D (i.e., read data) and the read completion notification to the host 20 (i.e., the transmitter of the read command) via the host interface 111 (step S9).

Incidentally, if it is determined in step S4 that the metadata added to the read data does not include the computation options (NO in step S4), the process of step S9 is executed. In other words, if the metadata attached to the read data does not include the computation options, the copy of the read data is not stored in main memory 113.

According to the above-described processing shown in FIG. 4, the copy of the read data to which the metadata including the computation options is added can be stored in the main memory 113, based on the read command transmitted from the host 20. Thus, the read data copied to the main memory 113 can be used in processing the computation instructions to be described below.

It has been described in FIG. 4 that the copy of the host data specified by the I/O command (read command) is not stored in the main memory 113 when the processing shown in FIG. 4 is executed. However, if the copy of the host data (read data) is already stored in the main memory 113 and its value is not rewritten, then the copy the host data may be read from the main memory 113 after the process in step S1 is executed, and the process of step S9 may be executed. Whether or not the copy of the host data is stored in the main memory 113 is determined by referring to the above-described page table 115.

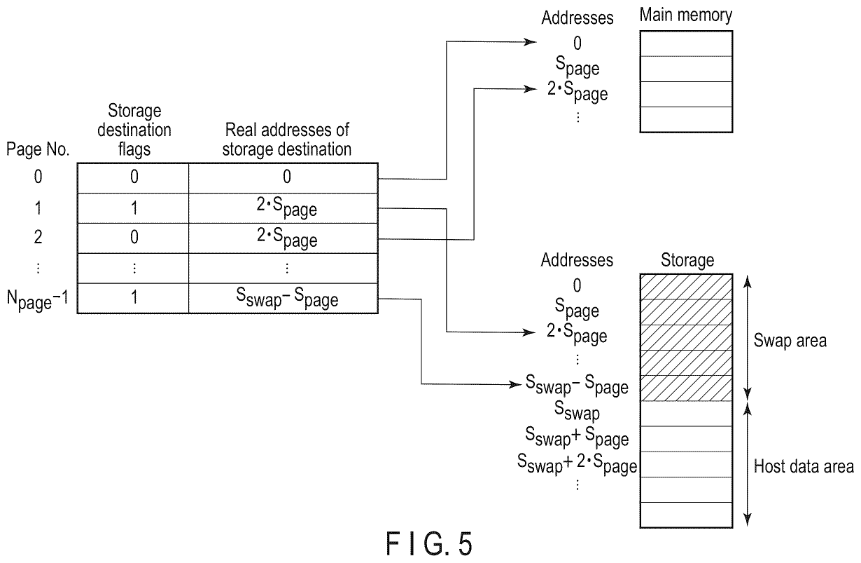

FIG. 5 shows an example of the data structure of the page table 115. As shown in FIG. 5, the page table 115 stores the storage destination flag and the actual address of the storage destination corresponding to the page number. In other words, each entry (storage destination flag and actual address of the storage destination) of the page table 115 is referred to by the page number. Incidentally, the page table 115 is represented, for example, in the form of an array table.

The page number is a number (identifier) assigned to a page corresponding to an area of a certain size into which the memory area where the copy of the host data is stored is divided.

In this example, in addition to the host data area where host data is stored, a swap area where a copy of the host data is temporarily stored is set in the storage 12. The storage destination flag indicates whether the data (a copy of the host data) in the page to which the corresponding page number is assigned is stored in the main memory 113 or the swap area set in the storage 12.

The actual address of the storage destination is indicative of the address of the main memory 113 or the storage 12 (swap area) where the data in the page to which the corresponding page number is assigned is stored.

More specifically, when the storage destination flag is 0, the storage destination flag indicates that the data in the page to which the corresponding page number is assigned is stored in the main memory 113. In this case, the actual address of the storage destination is indicative of the address of the main memory 113.

More specifically, when the storage destination flag is 1, the storage destination flag indicates that the data in the page to which the corresponding page number is assigned is stored in the swap area set in the storage 12. In this case, the actual address of the storage destination is indicative of the address of the swap area.

In FIG. 5, N_{page} is indicative of the total number of pages. In other words, the page table 115 shown in FIG. 5 includes N_{page} entries. S_{page} is the page size, and S_{swap} is the swap size (i.e., the size of the swap area). The unit of size is bytes.

As described above, the virtual address is represented by the page number and the page offset, and the page number is assumed to be the high-order log₂Npage bit value of the virtual address. In this case, in the present embodiment, the page number can be obtained from the virtual address computed from the computation options associated with the host data (i.e., the computation options included in the metadata attached to the host data) as described above, and whether or not the host data is stored in the main memory 113 can be determined by referring to the entry (storage destination flag) of the page table 115 by the page number.

In addition, it has been described in FIG. 4 that a free area in the main memory 113 for storing the read data (variable D) exists. If such a free area does not exist, such a free area needs to be secured by using the above-described swap area.

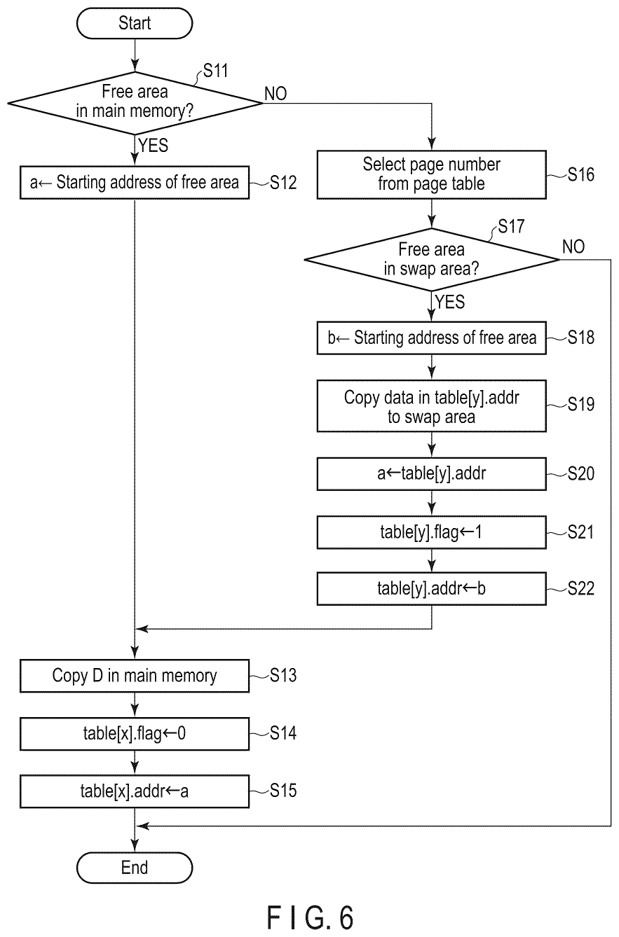

An example of a process (paging algorithm) for securing a free area of the main memory 113 will be described below with reference to FIG. 6. Incidentally, the processing shown in FIG. 6 is executed in step S6 shown in FIG. 4.

First, since the read data (i.e., host data specified by the I/O command) needs to be stored in the main memory 113 in step S6 shown in FIG. 4, the memory management circuit 116 determines whether or not there is a free area (i.e., contiguous free area for one page) to store the read data in the main memory 113 (step S11).

If it is determined that there is a free area in the main memory 113 (YES in step S11), the memory management circuit 116 stores a start address (actual address) of the free area in the main memory 113 in variable a (step S12).

When the process in step S12 is executed, the memory management circuit 116 copies the variable D to the main memory 113, based on the variable a (step S13). In this case, the read data stored in the variable D is stored in the address of the main memory 113, which is stored in the variable a.

In addition, the memory management circuit 116 obtains page number x from the virtual address computed from the computation options included in the metadata attached to the read data. The memory management circuit 116 sets the value of the storage destination flag (table [x].flag) of the entry (hereinafter referred to as a first target entry) in the page table 115 referred to by the obtained page number x to 0 (step S14).

Furthermore, the memory management circuit 116 sets the value of the variable a to the actual address of the storage destination (table [x].addr) of the first target entry (step S15).

In contrast, if it is determined in step S11 that there is no free area in the main memory 113 (NO in step S11), the memory management circuit 116 selects page number y where the value of the storage destination flag is 0, by referring to the page table 115 (step S16).

Next, the memory management circuit 116 determines whether or not there is a free area (i.e., a contiguous free area for one page) in the above-described swap area set in the storage 12 (step S17).

If it is determined that there is a free area in the swap area (YES in step S17), the memory management circuit 116 stores a start address (actual address) of the free area in the swap area, in variable b (step S18).

When the process in step S18 is executed, the memory management circuit 116 copies the data (data for one page) stored in the real address (table [y].addr) of the storage destination of the entry (hereinafter referred to as a second target entry) in the page table 115 referred to by page number y, to the address of the swap area stored in the variable b (step S19).

Next, the memory management circuit 116 stores the value of the actual address of the storage destination of the second target entry, in the variable a (step S20).

In addition, the memory management circuit 116 sets the value of the storage destination flag (table [y].flag) of the second target entry to 1 (step S21).

Furthermore, the memory management circuit 116 sets the value of the variable b to the actual address of the storage destination of the second target entry (step S22).

When the process in step S22 is executed, the above-described processes in steps S13 to S15 are executed.

According to the processing shown in FIG. 6, if there is no free area in the main memory 113 where the variable D is to be copied, copying the data stored in the main memory 113 to the swap area of the storage 12 enables the variable D to be copied to the memory area of the main memory 113 where the data is stored.

Incidentally, if it is determined in step S17 that there is no free area in the swap area (NO in step S17), the variable D cannot be copied to the main memory 113, and the processing shown in FIG. 6 ends.

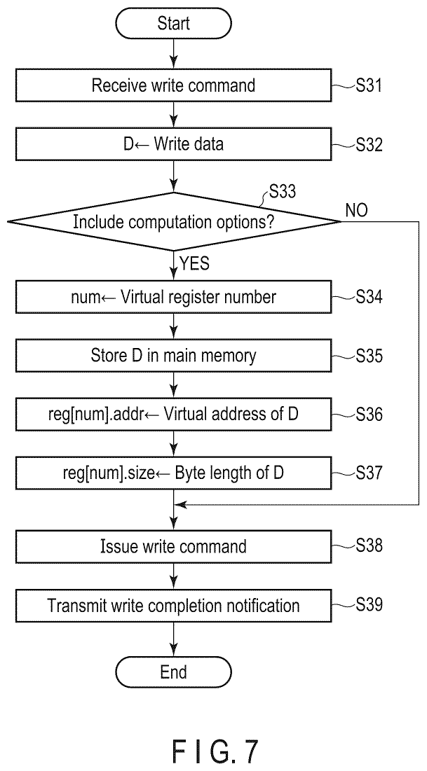

FIG. 7 is a flowchart showing an example of the procedure of the accelerator 11 operating in the CwW mode. The CwW mode is an operation mode for copying the host data (write data) specified by the write command from the host 20 to the main memory 113.

First, the host interface 111 receives the write command (I/O command) from the host 20 (step S31). The write command received in step S31 includes the write data and the logical address to be used to access the write data.

When the process in step S31 is executed, the memory management circuit 116 stores the write data included in the write command received in step S31, in the variable D (step S32).

Next, the memory management circuit 116 determines whether or not the metadata added to the write data includes a computation option (step S33).

If determining that the metadata attached to the write data includes a computation option (YES in step S33), the memory management circuit 116 stores the virtual register number calculated based on the computation option (content identifier) in variable num (step S34).

Next, the memory management circuit 116 stores the variable D (write data) in a free area of the main memory 113 (step S35). Although detailed description is omitted, in this step S35, the same process as the process described above with reference to FIG. 6 is executed in step S35.

When the process of step S35 is executed, the memory management circuit 116 set the virtual address indicative of the memory area of the main memory 113 where the variable D is copied, in the virtual register table 114, as a virtual address corresponding to the variable num (i.e., a virtual address referenced by the virtual register number stored in the variable num). In other words, the first virtual address of the copy destination of the variable D is set in the virtual address field (reg [num].addr) of the variable num-th virtual register (step S36).

Furthermore, the memory management circuit 116 sets the data size of the variable D in the virtual register table 114 as the data size corresponding to the variable num (i.e., the data size referred to by the virtual register number stored in the variable num). In other words, the byte length of the variable D is set in the data size field (reg [num].size) of the variable num-th virtual register (step S37).

Next, the storage interface 112 issues (transmits) the write command received in step S31 to the storage 12 (step S38).

When the process of step S38 is executed, the write data is written to the storage 12, based on the logical address included in the write command. In this case, the memory management circuit 116 receives a write completion notification from the storage 12 via the storage interface 112. The memory management circuit 116 transmits the received write completion notification to the host 20 (i.e., the transmitter of the write command) (step S39).

Incidentally, if it is determined in step S33 that the metadata added to the write data does not include the computation options (NO in step S33), the processes in steps S38 and S39 are executed. In other words, if the metadata attached to the write data does not include the computation options, the copy of the write data is not stored in main memory 113.

According to the above-described processing shown in FIG. 7, the copy of the write data to which the metadata including the computation options is added can be stored in the main memory 113, based on the write command transmitted from the host 20. Thus, the write data copied to the main memory 113 can be used in processing the computation instructions to be described below.

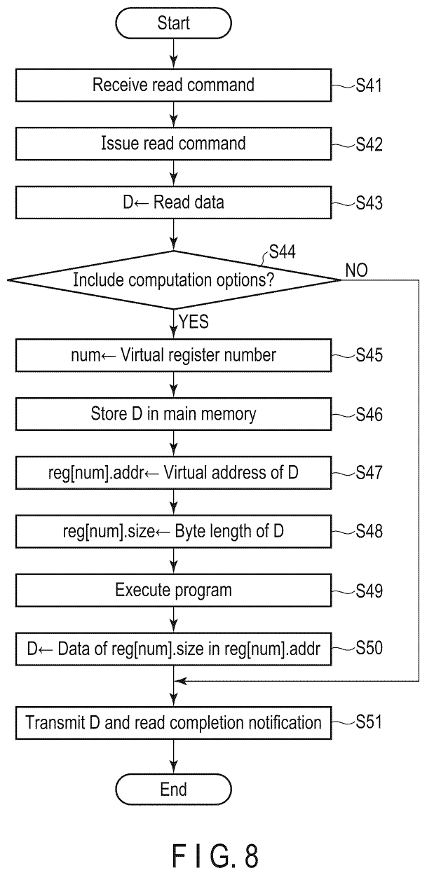

FIG. 8 is a flowchart showing an example of the procedure of the accelerator 11 operating in the CoR mode. The CoR mode is an operation mode for processing the computation instructions using the host data (read data) specified by the read command from the host 20.

First, processes in steps S41 to S48, which correspond to the above-described processes in steps S1 to S8 shown in FIG. 4, are executed.

In this case, the virtual registers in the present embodiment include program registers. A sequence (i.e., a program) of the computation instructions (secure computation instructions) is stored in the program register. The computation processing circuit 117 executes the program stored in the program register by referring to the virtual register table 114 (step S49). Incidentally, executing the program in step S49 corresponds to processing the computation instructions using the read data.

When the process in step S49 is executed, the data of the processing result of step S49 (i.e., the processing result of the computation instructions using the read data) is assumed to be stored in the virtual address set in the virtual address field (reg [num].addr) of the variable num-th virtual register.

In this case, the memory management circuit 116 reads the data of byte length (number of bytes) of the data size set in the data size field (reg [num].size) of the virtual register, from the virtual address set in the virtual address field of the variable num-th virtual register, and copies the data to the variable D, by referring to the virtual register table 114 (step S50).

When the process in step S50 is executed, a process in step S51, which corresponds to the above-described process in step S9 shown in FIG. 4, is executed.

Incidentally, the program is assumed to end with a Return instruction (Return num) using the variable num as an argument.

If it is determined in step S44 that the metadata added to the read data does not include the computation options (NO in step S44), the process in step S51 is executed.

According to the above-described process shown in FIG. 8, the computation instructions can be processed based on the read command transmitted from the host 20 and the processing result can be returned to the host 20 as the read data. In addition, the copy of the processing result of the computation instructions using the read data is stored in the main memory 113.

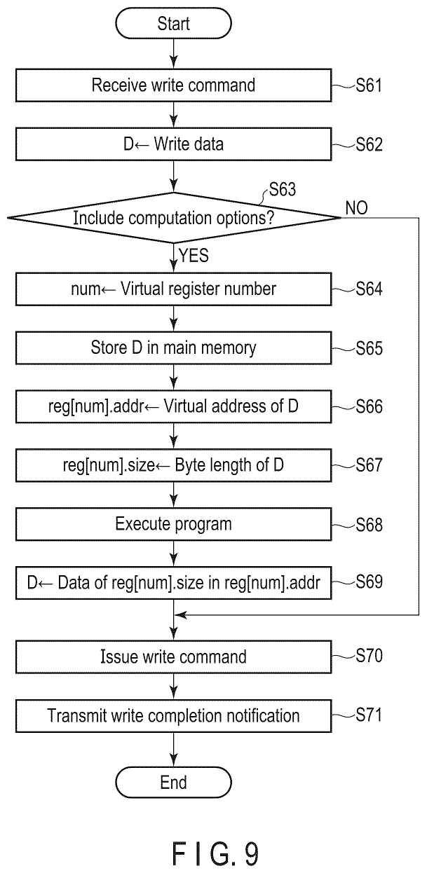

FIG. 9 is a flowchart showing an example of the procedure of the accelerator 11 operating in the CoW mode. The CoW mode is an operation mode for processing the computation instructions using the host data (write data) specified by the write command from the host 20.

First, processes in steps S61 to S67, which correspond to the above-described processes in steps S31 to S37 shown in FIG. 7, are executed.

Next, the computation processing circuit 117 executes the program stored in the program register by referring to the virtual register table 114 (step S68). Incidentally, executing the program in step S68 corresponds to processing the computation instructions using the write data.

When the process in step S68 is executed, the data of the processing result of step S68 (i.e., the processing result of the computation instructions using the write data) is assumed to be stored in the virtual address set in the virtual address field (reg [num].addr) of the variable num-th virtual register.

In this case, the memory management circuit 116 reads the data of byte length (number of bytes) of the data size set in the data size field (reg [num].size) of the virtual register, from the virtual address set in the virtual address field of the variable num-th virtual register, and copies the data to the variable D, by referring to the virtual register table 114 (step S69).

When the process in step S69 is executed, processes in steps S70 and S71, which correspond to the above-described processes in steps S38 and S39 shown in FIG. 7, are executed. In step S70, a write command (a write command for the variable D) including the above variable D as the write data is assumed to be transmitted to the storage 12.

Incidentally, the program is assumed to end with a Return instruction (Return num) using the variable num as an argument.

If it is determined in step S63 that the metadata added to the write data does not include the computation options (NO in step S63), the processes of steps S70 and S71 are executed.

According to the above-described process shown in FIG. 9, the computation instructions can be processed based on the write command transmitted from the host 20 and the processing result can be written to the storage 12 as the write data. In addition, the copy of the processing result of the computation instructions using the write data is stored in the main memory 113.

In the above-described Torus Fully Homomorphic Encryption (TFHE), bootstrapping processes referred to as Gate Bootstrapping, Circuit Bootstrapping, and the like, which reduce noise, are defined. These bootstrapping processes include encryption key switching processes referred to as Public Functional Key Switching and Private Functional Key Switching.

The Public Functional Key Switching corresponds to, for example, a process of generating a TLWE (or TRWE) cipher text C_{b} obtained by encrypting a plain text F (x₁, x₂, . . . , . . . , xₚ) with a key K_{b}, using a key-switching key KSK[Kₐ→K_{b}], from p TLWE cipher texts C_{a,z} (1≤z≤p) obtained by encrypting p plain texts X_{a,z} (1≤z≤p) with a key Kₐ. Incidentally, it is expressed that C_{b}=PubKS(KSK[Kₐ→K_{b}], F, Cₐ). In addition, Cₐ=(C_{a,1}, C_{a,2}, . . . , C_{a,p}). Furthermore, F is, for example, any univariate function that outputs the source of the torus polynomial ring to be shown below. However, the identity function (F(x)=x) may be used as F.

$${𝕋}_{N} [ x ] = 𝕋 [ x ] / ( {x}^{N} + 1 )$$

Incidentally, the key-switching key KSK[Kₐ→K_{b}] is a sequence of a two-dimensional TLWE (or TRWE) sample, and KSK[Kₐ→K_{b}] [i, j] (1≤i≤n, 1≤j≤t), which is its (i, j) element, is a key obtained by encrypting a value (plain text Kₐ[i]/2^{j}) obtained by dividing an i-th element (plain text) of key Kₐ by 2^{j}, with a key K_{b} or a public key for the key K_{b}.

The Private Functional Key Switching corresponds to, for example, a process of generating a TLWE (or TRWE) cipher text C_{b} obtained by encrypting a plain text F (x₁, x₂, . . . , xₚ) with a key K_{b}, using a key-switching key KSK[Kₐ→K_{b}, F], from p TLWE cipher texts C_{a,z} (1≤z≤p) obtained by encrypting p plain texts x_{a,z} (1≤z≤p) with a key Kₐ. Incidentally, it is expressed C_{b}=PrvKS(KSK[Kₐ→K_{b}, F], Cₐ). In addition, Cₐ=(C_{a,1}, C_{a,2}, . . . , C_{a,p}). Furthermore, F is any p-variable function that outputs the source of the above-described torus polynomial ring.

Incidentally, the key-switching key KSK[Kₐ→K_{b}, F] is a sequence of a three-dimensional TLWE (or TRWE) sample, and KSK[Kₐ→K_{b}, F] [z, i, j] (1≤z≤p, 1≤i≤n, 1≤j≤t), which is its (z, i, j)-th element, is a key obtained by encrypting a plain text F (0, . . . , 0, Kₐ[i]/2^{j}, 0, . . . , 0) with a key K_{b} or a public key for the key K_{b}. Kₐ[i]/2^{j} is a z-th argument of the function F.

The n described in the above-described Public Functional Key Switching and Private Functional Key Switching is the bit length of the key Kₐ, and t is the number of digits of the binary integer value in a case where each of n+1 torus values of the TLWE cipher text C_{a,z} is decomposed into binary integer values of 0 or 1. In addition, for simplicity of descriptions, it is assumed that the above plain texts x_{a,z} (1≤z≤p) and the output of the function F are both 1-bit values.

Executing the encryption key switching process of generating M cipher texts C_{b,1}, C_{b,2}, . . . , C_{b,M} obtained by encrypting plain text F(x) with M keys K_{b,1}, K_{b,2}, . . . , K_{b,M} respectively, from cipher text Cₐ where the TLWE cipher text obtained by encrypting the plain text x with the key Kₐ is Cₐ, is assumed.

Incidentally, when the encryption key switching process is Public Functional Key Switching, M-time Public Functional Key Switching PubKS (KSK[Kₐ→K_{b}, 1], F, Cₐ), PubKS (KSK[Kₐ→K_{b}, 2], F, Cₐ) . . . , PubKS (KSK[Kₐ→K_{b,M}], F, Cₐ) are executed using M key-switching keys KSK[Kₐ→K_{b}, 1], KSK [Kₐ→K_{b,2}], . . . , KSK [Kₐ→K_{b,M}], in order to generate M cipher texts C_{b,1}, C_{b,2}, . . . , C_{b,M} obtained by encrypting the plain text F(x) with M keys K_{b,1}, K_{b,2}, . . . , K_{b,M} respectively from the cipher text Cₐ.

In addition, when the encryption key switching process is Private Functional Key Switching, M-time Private Functional Key Switching PubKS (KSK[Kₐ→K_{b,1}, F], Cₐ), PubKS (KSK[Kₐ→K_{b,2}, F], Cₐ) . . . , PubKS (KSK[Kₐ→K_{b,M}, F], Cₐ) are executed using M key-switching keys KSK[Kₐ→K_{b,1}, F], KSK [Kₐ→K_{b,2}, F], . . . , KSK[Kₐ→K_{b,M}, F], in order to generate M cipher texts C_{b,1}, C_{b,2}, . . . , C_{b,M} obtained by encrypting the plain text F(x) with M keys K_{b,1}, K_{b,2}, . . . , K_{b,M} respectively from the cipher text Cₐ.

Incidentally, M keys K_{b,1}, K_{b,2}, . . . , K_{b,M} are keys held by different users 1, 2, . . . , M, respectively, and the cipher text C_{b,k} (1≤k≤M) can be decrypted by only user k using key K_{b,k}.

In multiparty computation of executing the above-described encryption key switching process using M key-switching keys (hereinafter referred to as key-switching multiparty computation), each user only needs to execute encryption and decryption once as compared to other multiparty computations using the fully homomorphic encryption. In the key-switching multiparty computation, however, the computation node (accelerator 11) needs to execute the same number of encryption key switching processes (Public Functional Key Switching and Private Functional Key Switching) as the number of users, and the time required for this process is increased.

Thus, the accelerator 11 (controller) that suppresses the time required for the computation processes such as the above-described key-switching multiparty computation will be described in the present embodiment.

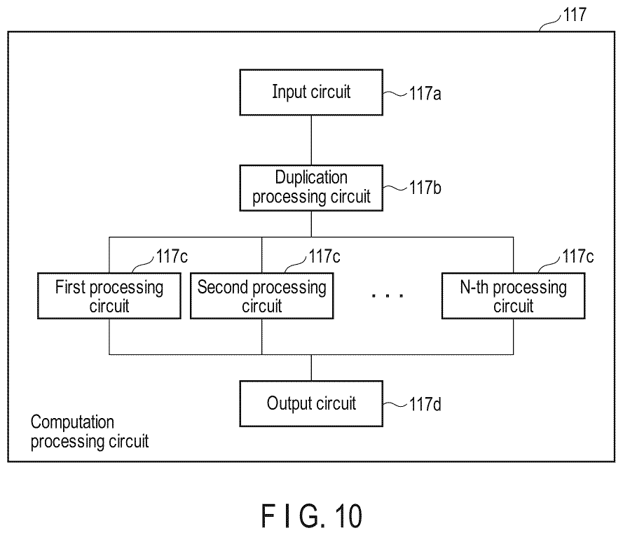

FIG. 10 is a diagram showing an example of a configuration of the computation processing circuit 117 provided in the accelerator 11 according to the present embodiment. As shown in FIG. 10, the computation processing circuit 117 includes an input circuit 117a, a duplication processing circuit 117b, plural processing circuits (first processing circuit, second processing circuit, . . . , N-th processing circuit) 117c and an output circuit 117d.

The input circuit 117a inputs, for example, host data and plural computation parameters specified by the I/O commands received by the host interface 111. For example, the host data is input from the storage interface 112.

The duplication processing circuit 117b obtains the plural host data by duplicating the host data (input data) input by the input circuit 117a.

The plural processing circuits 117c execute in parallel the computation processes using plural parameters input by the input circuit 117a for the plural host data obtained by the duplication processing circuit 117b.

The output circuit 117d outputs the results of the computation in each of the plural processing circuits 117c. Incidentally, the computation results are output to, for example, the host interface 111.

If it is assumed that the number of the plural processing circuits 117c is N (N is an integer greater than or equal to 2) and that the number of the plural computation parameters is M (M is an integer greater than or equal to 2), the duplication processing circuit 117b is assumed to duplicate the host data to obtain the same number of host data as the computation parameters.

In addition, the plural processing circuits (first to N processing circuits) 117c can execute N-time computation processes in parallel per round. For example, the processing circuits can execute, for example, the computation processes using M computation parameters (i.e., M-time computation processes) for the computation time in ceil (M/N) rounds.

In addition, it has been described that the host data is input from the storage interface 112, but the host data may be input from the host interface 111. Moreover, it has been described that the computation results in each of the plural processing circuits 117c are output to the host interface 111, but the computation results may be output to the storage interface 112.

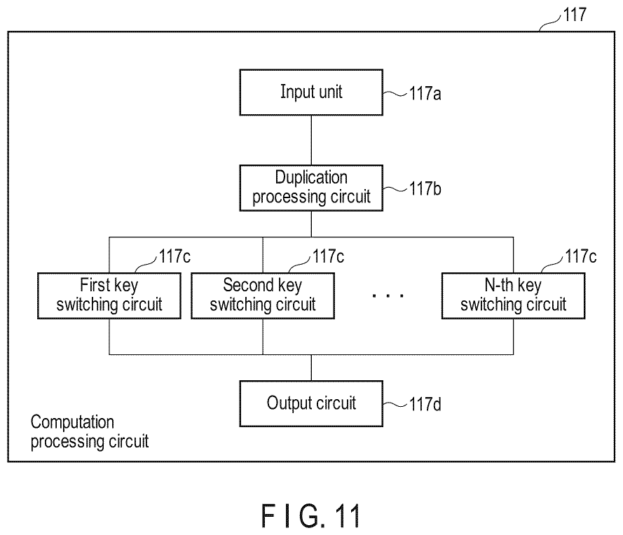

The configuration in which the plural computation processes using plural parameters are executed in parallel by the plural processing circuits 117c in FIG. 10. In consideration of executing the above-described encryption key switching process (key-switching multiparty computation), the computation processing circuit 117 may be configured to include plural key switching circuits (first key switching circuit, second key switching circuit, . . . , N-th key switching circuit) 117c as the plural processing circuits 117c as shown in FIG. 11.

In this case, the input circuit 117a inputs, for example, the cipher text Cₐ (cipher text of the fully homomorphic encryption) as the host data. In addition, the input circuit 117a inputs, for example, different key-switching keys KSK[Kₐ→K_{b}, 1], KSK[Kₐ→K_{b,2}], . . . , KSK[Kₐ→K_{b,M}] as M computation parameters.

In addition, the duplication processing circuit 117b obtains M cipher texts Cₐ by duplicating the cipher text Cₐ (input cipher text) input by the input circuit 117a.

The plural key switching circuits 117c execute in parallel the encryption key switching process (Public Functional Key Switching) using the key-switching keys KSK[Kₐ→K_{b}, 1], KSK[Kₐ→K_{b,2}], KSK[Kₐ→K_{b,M}] for M cipher texts Cₐ. In other words, each of the plural key switching circuits 117c executes the encryption key switching process using the key-switching key corresponding to the key switching circuit 117c.

The output circuit 117d outputs cipher texts C_{b,1} (=PubKS (KSK[Kₐ→K_{b,1}], F, Cₐ)), C_{b,2} (=PubKS (KSK[Kₐ→K_{b,2}], F, Cₐ)), . . . , C_{b,M} (=PubKS (KSK[Kₐ→K_{b,M}], F, Cₐ)) as results of the encryption key switching processes in each of the plural key switching circuits 117c.

It has been described that the Public Functional Key Switching is executed as the encryption key switching process. If the Private Functional Key Switching is executed as the encryption key switching process, the M computation parameters are KSK[Kₐ→K_{b,1}, F], KSK[Kₐ→K_{b,2}, F], . . . , KSK[Kₐ→K_{b,M}, F], and the plural key switching circuits 117c execute the encryption key switching processes (Private Functional Key Switching) using the key-switching keys KSK[Kₐ→K_{b,1}, F], KSK[Kₐ→K_{b,2}, F], . . . , KSK[Kₐ→K_{b,M}, F] for the M cipher texts Cₐ. In this case, the output circuit 117d outputs cipher texts C_{b,1} (=PrvKS (KSK[Kₐ→K_{b,1}, F], Cₐ)), C_{b,2} (=PrvKS (KSK[Kₐ→K_{b,2}, F], Cₐ)), . . . , C_{b,M} (=PrvKS (KSK[Kₐ→K_{b,M}, F], Cₐ)) as the results of the encryption key switching processes in each of the plural key switching circuits 117c.

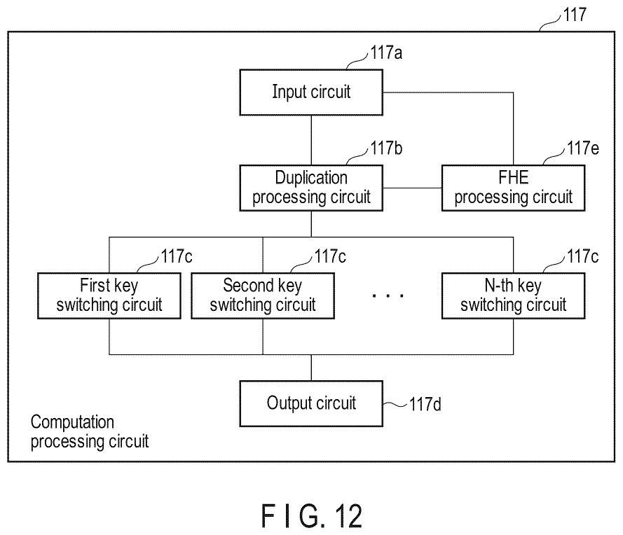

In addition, it has been described in FIG. 11 that the encryption key switching processes are executed in the computation processing circuit 117. If he bootstrapping process is executed in the computation processing circuit 117, the computation processing circuit 117 may be configured to further include an FHE processing circuit 117e as shown in FIG. 12.

In this case, the input circuit 117a further inputs the bootstrapping key in addition to the cipher text Ca. The FHE processing circuit 117e executes a bootstrapping process (Bootstrapping TLWE-to-TLWE process) for the cipher text Ca input by the input circuit 117a, using the bootstrapping key input by the input circuit 117a. The duplication processing circuit 117b obtains results of plural bootstrapping processes by duplicating the results of the bootstrapping processes. The plural key switching circuits 117c execute the encryption key switching processes using key-switching keys for the results of the plural bootstrapping processes. The output circuit 117d outputs the result of the encryption key switching process in each of the plural key switching circuits 117c.

According to the above-described configuration shown in FIG. 12, noise in the cipher text Ca (input cipher text) can be reduced by the bootstrapping process prior to the process of the duplication processing circuit 117b (i.e., duplication process) and the processes of the plural key switching circuits 117c (i.e., encryption key switching processes).

Incidentally, for example, the above-described FHE processing circuit 117e may be configured to execute the homomorphic computation (private computation) on the cipher text Ca and execute the bootstrapping process on the result of the homomorphic computation.

It is assumed that each of the above-described circuits 117a to 117e shown in FIG. 10 to FIG. 12 are realized by hardware. However, at least some of the circuits 117a to 117e may be realized by executing a predetermined program (i.e., software) by a processor provided in the accelerator 11.

In addition, the above-described computation process and the encryption key switching process described with reference to FIG. 10 to FIG. 12 correspond to, for example, the above-described processes executed in step S49 shown in FIG. 8 or step S68 shown in FIG. 9.

In addition, it is assumed in, for example, FIG. 10 that the computation processing circuit 117 provided in one accelerator 11 includes the plural processing circuits (first processing circuit, second processing circuit, . . . , N-th processing circuit) 117c. However, the plural processing circuits 117c may be arranged separately in plural accelerators connected via a network. In such a configuration, the plural processing circuits located in the plural accelerators respectively can execute the computation processes in parallel by operating the plural accelerators in coordination. The plural processing circuits 117c shown in FIG. 10 have been described, but the plural key switching circuits (first key switching circuit, second key switching circuit, . . . , N-th key switching circuit) 117c shown in FIG. 11 and FIG. 12 are also configured in the same manner.

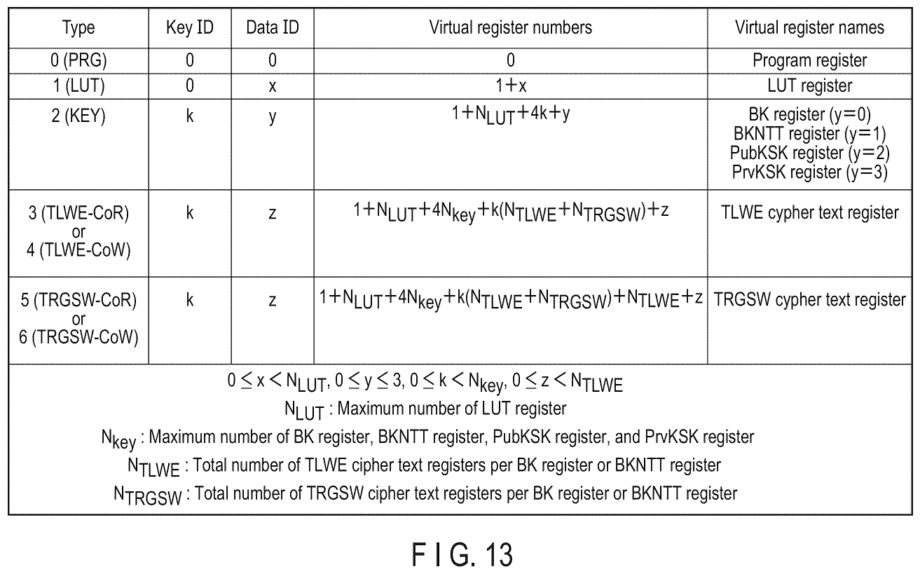

As described above, the virtual register numbers in the virtual register table 114 are calculated from the content identifiers included in the computation options accompanying the host data, and an example of a method of computing the virtual register numbers will be described with reference to FIG. 13. The virtual registers in the present embodiment include the program register, LUT register, BK register, BKNTT register, PubKSK register, PrvKSK register, TLWE cipher text register, and TRGSW cipher text register.

A program (i.e., a sequence of the computation instructions) is stored in the program register. The LUT register stores a test vector of the TFHE. The test vector (LUT) stored in the LUT register corresponds to, for example, coefficients for a predetermined function (polynomial).

The BK register stores the bootstrapping key of the TFHE. The bootstrapping key stored in the BK register is used in Gate Bootstrapping (GBS) of the TFHE, and the like. Incidentally, the bootstrapping key may be used in, for example, Programmable Bootstrapping (PBS). The PBS is a bootstrapping method of outputting TLWE sample that is a result of evaluating an input TLWE sample (cipher text) by a predetermined function in a homomorphic manner after reducing its noise to a noise level of a new (fresh) sample.

The BKNTT register stores the bootstrapping key of the TFHE subjected to a number theory transform process.

The PubKSK register and the PrvKSK register store the key-switching keys of TFHE. More specifically, the PubKSK register stores the key-switching key used in the Public Functional Key Switching. The PrvKSK register stores the key-switching key used in the Private Functional Key Switching. The key-switching keys stored in the PubKSK register and the PrvKSK registers are usually used in the post-processing of the above-described GBS or PBS (i.e., bootstrapping process).

The TLWE cipher text register stores the TLWE sample. There are two types of TLWE cipher text registers, i.e., TLWE-COR (COR register) and TLWE-COW (CoW register).

The TRGSW cipher text register stores the TRGSW sample. There are two types of TRGSW cipher text registers, i.e., TRGSW-COR (COR register) and TRGSW-CoW (CoW register).

In FIG. 13, for example, when Type is 0, Key ID is 0, and Data ID is 0, the virtual register number “0” is computed from the Type, Key ID, and Data ID (i.e., content identifier), indicating that the virtual register is a program register.

In addition, in FIG. 13, for example, when Type is 0, Key ID is 0, and Data ID is x, the virtual register number “1+x” is computed from the Type, Key ID, and Data ID (i.e., content identifier), indicating that the virtual register is the LUT register.

In addition, in FIG. 13, for example, when Type is 2, Key ID is k, and Data ID is y, the virtual register number “1+N_{LUT}+4k+y” is computed from the Type, Key ID, and Data ID (i.e., content identifier), indicating that the virtual register is the BK register, BKNTT register, PubKSK register, or PrvKSK register. Incidentally, the virtual register is the BK register when y=0, the virtual register is the BKNTT register when y=1, the virtual register is the PubKSK register when y=2, and the virtual register is the PrvKSK register when y=3.

In addition, in FIG. 13, for example, when Type is 3 or 4, Key ID is k, and Data ID is z, the virtual register number “1+N_{LUT}+4N_{key}+k(N_{TLWE}+N_{TRGSW})+z” is computed from the Type, Key ID, and Data ID (i.e., the content identifier), indicating that the virtual register is a TLWE cipher text register.

In addition, in FIG. 13, for example, when Type is 5 or 6, Key ID is k, and Data ID is z, the virtual register number “1+N_{LUT}+4N_{key}+k(N_{TLWE}+N_{TRGSW})+N_{TLWE}+z” is computed from the Type, Key ID, and Data ID (i.e., the content identifier), indicating that the virtual register is a TRGSW cipher text register.

Incidentally, x is assumed to be an integer greater than or equal to 0 and less than N_{LUT} (0≤x<N_{LUT}). y is assumed to be an integer greater than or equal to 0 and less than or equal to 3 (0≤y≤3). k is assumed to be an integer greater than or equal to 0 and less than N_{key} (0≤k<N_{key}). z is assumed to be an integer greater than or equal to 0 and less than N_{TLWE} (0≤≤Z<N_{TLWE}).

NLUT is the maximum number of LUT registers. N_{key} is the maximum number of BK registers, BKNTT registers, PubKSK registers, and PrvKSK registers. N_{TLWE} is the total number of TLWE cipher text registers per BK register or BKNTT register. N_{TRGSW} is the total number of TRGSW cipher text registers per BK register or BKNTT register.

Incidentally, it has been described that the accelerator 11 of the present embodiment operates in each of the CwR, CwW, COR, and CoW modes, and the operation mode of the accelerator 11 is specified in the computation options.

More specifically, when the read command is received from the host 20 and the type of the computation option associated with the read data is TLWE-Cow, the operation mode of the accelerator 11 is the CwR mode.

In addition, when the write command is received from the host 20 and the type of the computation option associated with the write data is TLWE-COR, the operation mode of the accelerator 11 is the CwW mode.

In addition, when the read command is received from the host 20 and the type of the computation option associated with the read data is TLWE-COR, the operation mode of the accelerator 11 is the CoR mode.

In addition, when the write command is received from the host 20 and the type of the computation option associated with the write data is TLWE-CoW, the operation mode of the accelerator 11 is the CoW mode.

The computation instruction of the present embodiment will be described below. An example of the computation instruction in the present embodiment is the secure computation instruction.

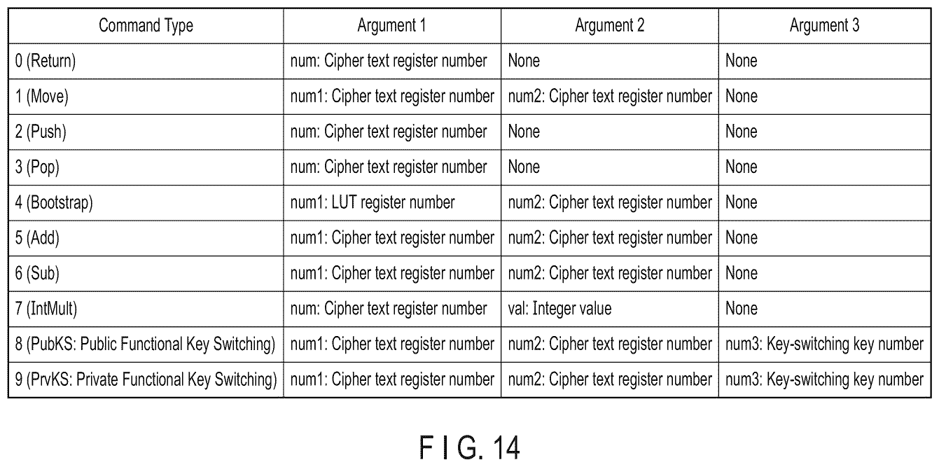

FIG. 14 shows an example of an instruction set of the secure computation instructions used by the accelerator 11 according to the present embodiment. In the example shown in FIG. 14, the instruction set of the secure computation instructions includes Return instruction, Move instruction, Push instruction, Pop instruction, Bootstrap instruction, Add instruction, Sub instruction, IntMult instruction, PubKS instruction, and PrvKS instruction as indicated by command types 0 to 9. In FIG. 14, for convenience, the virtual register number for referring to the cipher text register is shown as the cipher text register number, and the virtual register number for referring to the LUT register is shown as the LUT register number.

The Return instruction uses the cipher text register number num as an argument. According to the Return instruction, the value of the cipher text register referred to by the cipher text register number num is transmitted to the host 20 or the storage 12. Incidentally, the value of the cipher text register is transmitted to the host 20 if the cipher text register is the CoR register or transmitted to the storage 12 if the cipher text register is the CoW register. After the value of the cipher text register is transmitted, the stack pointer is set to 0 to manage the reference position of the stack area included in the virtual address space.

The Move instruction uses cipher text register numbers num1 and num2 as arguments. According to the Move instruction, the value of the cipher text register referred to by the cipher text register number num1 is copied to the cipher text register referred to by the cipher text register number num2.

The Push instruction uses the cipher text register number num as an argument. According to the Push instruction, the value of the cipher text register referred to by the cipher text register number num is copied to the starting part of the stack area included in the virtual address space, and the stack pointer is decremented (1 is subtracted from the value of the stack pointer).

The Pop instruction uses the cipher text register number num as an argument. According to the Pop instruction, the value of the starting part of the stack area in the virtual address space is copied to the cipher text register referred to by the cipher text register number num, and the stack pointer is incremented (1 is added to the value of the stack pointer).

The Bootstrap instruction uses the LUT register number num1 and the cipher text register number num2 as arguments. According to the Bootstrap instruction, GBS or PBS for the value of the cipher text register referred to by the cipher text register number num2 is executed using the LUT register referred to by the LUT register number num1. The GBS is executed when the LUT register number num1=0, and the PBS is executed when the LUT register number num1>0. The result (output value) of execution of the GBS or PBS is copied to the cipher text register referred to by the cipher text register number num2. For example, if the value of the LUT register referred to by the LUT register number num1 is the LUT for the function f(x) and if the value of the cipher text register referred to by the cipher text register number num2 before execution of the Bootstrap instruction is the TLWE sample for x, the value of the cipher text register referred to by the cipher text register number num2 after execution of the Bootstrap instruction is the TLWE sample for f(x).

The Add instruction uses the cipher text register numbers num1 and num2 as arguments. According to the Add instruction, the value of the cipher text register referred to by the cipher text register number num1 and the value of the cipher text register referred to by the cipher text register number num2 are added for each component, and the addition result (computation result) is copied to the cipher text register referred to by the cipher text register number num1.

The Sub instruction uses the cipher text register numbers num1 and num2 as arguments. According to the Sub instruction, the value of the cipher text register referred to by the cipher text register number num2 is subtracted from the value of the cipher text register referred to by the cipher text register number num1, for each component, and the subtraction result (computation result) is copied to the cipher text register referred to by the cipher text register number num1.

The IntMult instruction uses the cipher text register number num and the integer value val as arguments. According to the IntMult instruction, the value of the cipher text register referred to by the cipher text register number num is multiplied by integer value val, for each component, and the multiplication result (computation result) is copied to the cipher text register referred to by the cipher text register number num.

The PubKS instruction uses the cipher text register numbers num1 and num2 and the key-switching key number num3 as arguments. Incidentally, the key-switching key number in the PubKS instruction is the virtual register number for referring to the PubKSK register. According to the PubKS instruction, the Public Functional Key Switching using the key-switching key stored in the PubKSK register referred to by the key-switching key number num3 is executed for the value of the cipher text register (i.e., the cipher text) referred to by the cipher text register number num1, and the cipher text subjected to the Public Functional Key Switching is stored in the cipher text register referred to by the cipher text register number num2. Incidentally, the function in the PubKS instruction is assumed to be, for example, an identity function (f(x)=x).

The PrvKS instruction uses the cipher text register numbers num1 and num2 and the key-switching key number num3 as arguments. Incidentally, the key-switching key number in the PrvKS instruction is the virtual register number for referring to the PrvKSK register. According to the PrvKS instruction, the Private Functional Key Switching using the key-switching key stored in the PrvKSK register referred to by the key-switching key number num3 is executed for the value of the cipher text register (i.e., the cipher text) referred to by the cipher text register number num1, and the cipher text subjected to the Private Functional Key Switching is stored in the cipher text register referred to by the cipher text register number num2. Incidentally, the k+1 key-switching keys for the Public Functional Key Switching are stored in the PrvKSK register referred to by the key-switching key number num3, as one key-switching key for the Private Functional Key Switching. More specifically, the key-switching key stored in the PrvKSK register is a key obtained by encrypting function (f u (x)=−Ku*x if u≤k, otherwise f_{u}(x)=1*x if u=k+1) in each of k+1 TLWE (or TRWE) samples, for x=k_i/2^{j} (1<i>n+1, 1≤j≤t). If k=1, two keys are counted as one key-switching key (PrvKSK) for Private Functional Key Switching.

Incidentally, plural PubKSK registers and PrvKSK registers may exist for one cipher text register, during the multiparty computation (key-switching multiparty computation). Therefore, the key-switching key number (virtual register number) for referring to the PubKSK register and PrvKSK register to be used is clearly indicated in the third argument of the PubKS instruction and PrvKS instruction.

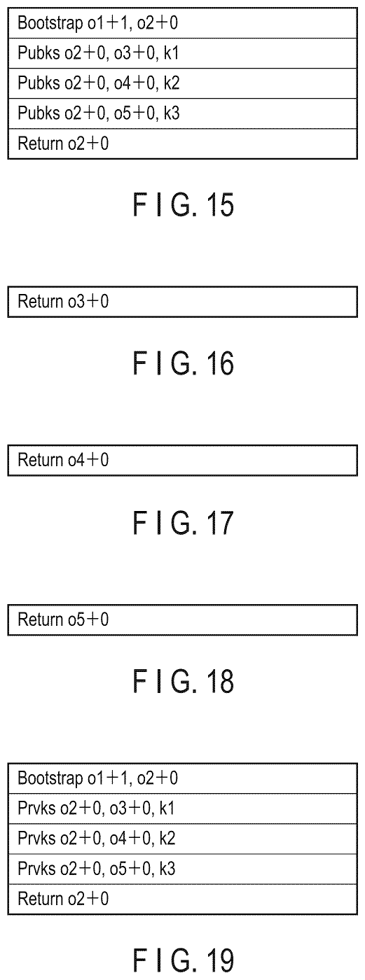

Next, FIG. 15 shows an example of the secure computation program (i.e., a program using the instruction set of secure computation instructions) stored in the program register. In FIG. 15, the secure computation instructions and the arguments of the secure computation instructions are arranged in the order in which the secure computation instructions are executed. In addition, in FIG. 15, the virtual register number (for example, cipher text register) is represented by the sum of the offset (o1, o2, o3, o4, o5) and Data ID values (0, 1, 2). In other words, the result of calculating the sum of the offset and Data ID values is specified as the virtual register number, in each secure computation instruction. In addition, k1 to k3 in FIG. 15 are key-switching key numbers.

In the example shown in FIG. 15, it is shown that after the Bootstrap instruction is executed, the PubKS instruction of specifying different key-switching keys is executed three times for the value of the cipher text register referred to by cipher text register number o2+0 and the value of the cipher text register is referred to by the cipher text register number o2+0 is finally returned.

More specifically, according to “bootstrap o1+1, o2+0”, the result of the bootstrapping process is stored in the cipher text register referred to by the cipher text register number o2+0. According to “pubks o2+0, o3+0, k1”, the PubKS using the value of the PubKSK register referred to by key-switching key number k1 is executed for the value of the cipher text register referred to by the cipher text register number o2+0, and the result of the PubKS is stored in the cipher text register referred to by the cipher text register number o3+0. According to “pubks o2+0, o4+0, k2”, the PubKS using the value of the PubKSK register referred to by key-switching key number k2 is executed for the value of the cipher text register referred to by the cipher text register number o2+0, and the result of the PubKS is stored in the cipher text register referred to by the cipher text register number o4+0. According to “pubks o2+0, o5+0, k3”, the PubKS using the value of the PubKSK register referred to by key-switching key number k3 is executed for the value of the cipher text register referred to by the cipher text register number o2+0, and the result of the PubKS is stored in the cipher text register referred to by the cipher text register number o5+0. According to “return o2+0”, the value of the cipher text register referred to by the cipher text register number o2+0 (i.e., the result of the bootstrapping process) is returned.

Incidentally, each of o1, o2, o3, o4, and o5 in the above-described secure computation program shown in FIG. 15 is the offset to the LUT register number and TLWE cipher text register number, and is calculated in the following manner.

$$o 1 = 1$$

$$o 2 = 1 + {N}_{LUT} + 4 {N}_{key} + k ( {N}_{TLWE} + {N}_{TRGSW} )$$

$$o 3 = 1 + {N}_{LUT} + 4 {N}_{key} + ( k + 1 ) ( {N}_{TLWE} + {N}_{TRGSW} )$$

$$o 4 = 1 + {N}_{LUT} + 4 {N}_{key} + ( k + 2 ) ( {N}_{TLWE} + {N}_{TRGSW} )$$

$$o 5 = 1 + {N}_{LUT} + 4 {N}_{key} + ( k + 3 ) ( {N}_{TLWE} + {N}_{TRGSW} )$$

In addition, each of the key-switching key numbers k1 to k3 used in the third argument in the PubKS instruction is assumed to be calculated in the following manner. In this case, y=2.

$$k 1 = 1 + {N}_{LUT} + 4 ( k + 1 ) + y$$

$$k 2 = 1 + {N}_{LUT} + 4 ( k + 2 ) + y$$

$$k 3 = 1 + {N}_{LUT} + 4 ( k + 3 ) + y$$

In the present embodiment, the three PubKS instructions in the above-described secure computation program shown in FIG. 15 can be processed in parallel by, for example, three (for example, first to third key switching circuits 117c) of the plural key switching circuits (first to N-th key switching circuits) 117c shown in FIG. 12. At this time, the input cipher text, the bootstrapping key, and three key-switching keys (PubKSK) are loaded into a predetermined virtual register in either the CwR mode (step S6 shown in FIG. 4) or the CwW mode (step S35 shown in FIG. 7) before the secure computation program shown in FIG. 15 is executed.

Next, FIG. 16 to FIG. 18 show an example of the secure computation program that is continuously executed after the secure computation program shown in FIG. 15 is executed. In FIG. 16 to FIG. 18, it is intended that the secure computation program (secure computation instruction) shown in FIG. 16, the secure computation program (secure computation instruction) shown in FIG. 17, and the secure computation program (secure computation instruction) shown in FIG. 18 are executed in order after the secure computation program shown in FIG. 15 is executed.

As shown in FIG. 16 to FIG. 18, the secure computation programs shown in FIG. 16 to FIG. 18 all include only the Return instructions. According to “return o3+0” shown in FIG. 16, the value of the cipher text register referred to by the cipher text register number o3+0 (i.e., the result of first PubKS) is returned. According to “return o4+0” shown in FIG. 17, the value of the cipher text register referred to by the cipher text register number o4+0 (i.e., the result of second PubKS) is returned. According to “return o5+0” shown in FIG. 18, the value of the cipher text register referred to by the cipher text register number o5+0 (i.e., the result of third PubKS) is returned.

In other words, according to the examples shown in FIG. 16 to FIG. 18, the results of the PubKS computed by the three-time PubKS instructions in the secure computation program shown in FIG. 15 are returned.

Incidentally, the above-described secure computation program shown in FIG. 15 to FIG. 18 may be executed in the CoR mode (step S49 shown in FIG. 8) or the CoW mode (step S68 shown in FIG. 9). This secure computation program is loaded into a program register in either the CwR mode (step S6 shown in FIG. 4) or the CwW mode (step S35 shown in FIG. 7) before the secure computation program is executed.

FIG. 19 shows another example of the secure computation program stored in the program register. Parts different from those in FIG. 15 will be mainly described.

In the example shown in FIG. 19, it is shown that after the Bootstrap instruction is executed, the PrvKS instruction of specifying different key-switching keys is executed three times for the value of the cipher text register referred to by cipher text register number o2+0 and the value of the cipher text register is referred to by the cipher text register number o2+0 is finally returned.

More specifically, according to “bootstrap o1+1, o2+0”, the result of the bootstrapping process is stored in the cipher text register referred to by the cipher text register number o2+0. According to “prvks o2+0, o3+0, k1”, the PrvKS using the value of the PrvKSK register referred to by key-switching key number k1 is executed for the value of the cipher text register referred to by the cipher text register number o2+0, and the result of the PrvKS is stored in the cipher text register referred to by the cipher text register number o3+0. According to “prvks o2+0, o4+0, k2”, the PrvKS using the value of the PrvKSK register referred to by key-switching key number k2 is executed for the value of the cipher text register referred to by the cipher text register number o2+0, and the result of the PrvKS is stored in the cipher text register referred to by the cipher text register number o4+0. According to “prvks o2+0, o5+0, k3”, the PrvKS using the value of the PrvKSK register referred to by key-switching key number k3 is executed for the value of the cipher text register referred to by the cipher text register number o2+0, and the result of the PrvKS is stored in the cipher text register referred to by the cipher text register number o5+0. According to “return o2+0”, the value of the cipher text register referred to by the cipher text register number o2+0 (i.e., the result of the bootstrapping process) is returned.

Incidentally, each of o1, o2, o3, o4, and o5 in the above-described secure computation program shown in FIG. 19 is the offset to the LUT register number and TRGSW cipher text register number, and is calculated in the following manner.

$$o 1 = 1$$

$$o 2 = 1 + {N}_{LUT} + 4 {N}_{key} + k ( {N}_{TLWE} + {N}_{TRGSW} ) + {N}_{TLWE}$$

$$o 3 = 1 + {N}_{LUT} + 4 {N}_{key} + ( k + 1 ) ( {N}_{TLWE} + {N}_{TRGSW} ) + {N}_{TLWE}$$

$$o 4 = 1 + {N}_{LUT} + 4 {N}_{key} + ( k + 1 ) ( {N}_{TLWE} + {N}_{TRGSW} ) + {N}_{TLWE}$$

$$o 5 = 1 + {N}_{LUT} + 4 {N}_{key} + ( k + 1 ) ( {N}_{TLWE} + {N}_{TRGSW} ) + {N}_{TLWE}$$

In addition, each of the key-switching key numbers k1 to k3 used in the third argument in the PrvKS instruction is assumed to be calculated in the following manner. In this case, y=3.

$$k 1 = 1 + {N}_{LUT} + 4 ( k + 1 ) + y$$

$$k 2 = 1 + {N}_{LUT} + 4 ( k + 2 ) + y$$

$$k 3 = 1 + {N}_{LUT} + 4 ( k + 3 ) + y$$

In the present embodiment, the three PrvKS instructions in the above-described secure computation program shown in FIG. 19 can be processed in parallel by, for example, three (for example, first to third key switching circuits 117c) of the plural key switching circuits (first to N-th key switching circuits) 117c shown in FIG. 12. At this time, the input cipher text, the bootstrapping key, and three key-switching keys (PrvKSK) are loaded into a predetermined virtual register in either the CwR mode (step S6 shown in FIG. 4) or the CwW mode (step S35 shown in FIG. 7) before the secure computation program shown in FIG. 19 is executed.

Although detailed explanations are omitted, the above-described secure computation programs shown in FIG. 16 to FIG. 18 may also be executed after the secure computation program shown in FIG. 19 is executed.

As described above, the accelerator 11 of the present embodiment corresponds to a controller that controls the CSD 10 (i.e., a computing storage device including the storage 12) that can be connected to the host 20, and includes a host interface 111 (first interface) that receives the I/O command specifying the host data (first host data) from the host 20, a storage interface 112 (second interface) that transmits and receives the host data to and from the storage 12, and a computation processing circuit 117. In the present embodiment, the computation processing circuit 117 inputs the host data (input data) and plural computation parameters, obtains plural host data by duplicating the host data, executes in parallel the computation processes using plural parameters on the obtained plural host data, and outputs the computation results.

More specifically, in the present embodiment, for example, the host data includes a cipher text of the fully homomorphic encryption, each of the plural computation parameters includes a different key-switching key, and each of the plural processing circuits 117c executes the encryption key switching process using the key-switching key corresponding to the processing circuit 117c.

In the present embodiment, with the above-described configuration, for example, even if plural computation processes (encryption key switching processes) using plural computation parameters (key-switching keys) need to be executed in the accelerator 11 (computation processing circuit 117), for example, similarly to the key-switching multiparty computation, the time required for the computation processes can be suppressed by executing the plural computation processes in parallel.

Incidentally, in the present embodiment, the computation processing circuit 117 may be configured to further include an FHE processing circuit 117e that executes a bootstrapping process on a cipher text of the fully homomorphic encryption, using the bootstrapping key input by the input circuit 117a. In such a configuration, the results of plural bootstrapping processes are obtained by duplicating the results of the bootstrapping processes, and the encryption key switching process is executed on each of the results of the plural bootstrapping processes. Furthermore, the FHE processing circuit 117e may be configured to execute the homomorphic computation (private computation) on the cipher text of the fully homomorphic encryption, and to execute the bootstrapping process on the result of the homomorphic computation.

In the present embodiment, it has been described that the plural computation processes (encryption key switching processes) using the plural computation parameters (key-switching keys) are executed, but the plural computation parameters correspond to, for example, plural users, and the computation process result in each of the plural processing circuits 117c is output to the host 20 used by the user corresponding to the computation parameter used in the processing circuit.

More specifically, according to the accelerator 11 of the present embodiment, for example, when a write command to write data to the storage 12 is received by the host interface 111, the encryption key switching process using the key-switching key (computation parameter) for the data (i.e., the cipher text encrypted using the key of a predetermined user using the host 20) is executed in the computation processing circuit 117, and the cipher text which is the result of the encryption key switching process (i.e., the cipher text of the fully homomorphic encryption) is written to the storage 12.

In contrast, for example, when the read command to read the data from the storage 12 is received by the host interface 111, the data specified by the read command is read from the storage 12 and input to the computation processing circuit 117. Incidentally, the data (read data) read from the storage 12 and input to the computation processing circuit 117 is a cipher text of the fully homomorphic encryption. The cipher text thus input to the computation processing circuit 117 is duplicated in the computation processing circuit 117 (duplication processing circuit 117b), and the encryption key switching processes using the plural key-switching keys (computation parameters) corresponding to the plural users respectively are executed in parallel by plural key switching circuits 117c. The results of the encryption key switching processes using the plural key-switching keys corresponding to the plural users are returned to the host 20 as responses to the above-described read command, and the host 20 transmits the results of the encryption key switching processes corresponding to the users, to the users, respectively. In this case, each of the plural users can decrypt the cipher text, i.e., the result of the encryption key switching process, which is returned to the host 20, using the user's key.

According to this configuration, the accelerator 11 that reduces the time required for the key-switching multiparty computation (i.e., accelerate the plural key-switching processes) can be realized.

It has been mainly described that the encryption key switching processes are executed in parallel and the results of the encryption key switching processes are returned to the host 20 when the read command is received by the host interface 111, but the accelerator 11 of the present embodiment may be configured such that, for example, when the write command is received by the host interface 111, the encryption key switching processes are executed in parallel and the results of the encryption key switching processes are written to the storage 12.

Incidentally, the host 20 of the present embodiment may be realized by, for example, a single information processing apparatus used by plural users or by, for example, plural information processing apparatuses connected to the CSD 10 via a network.

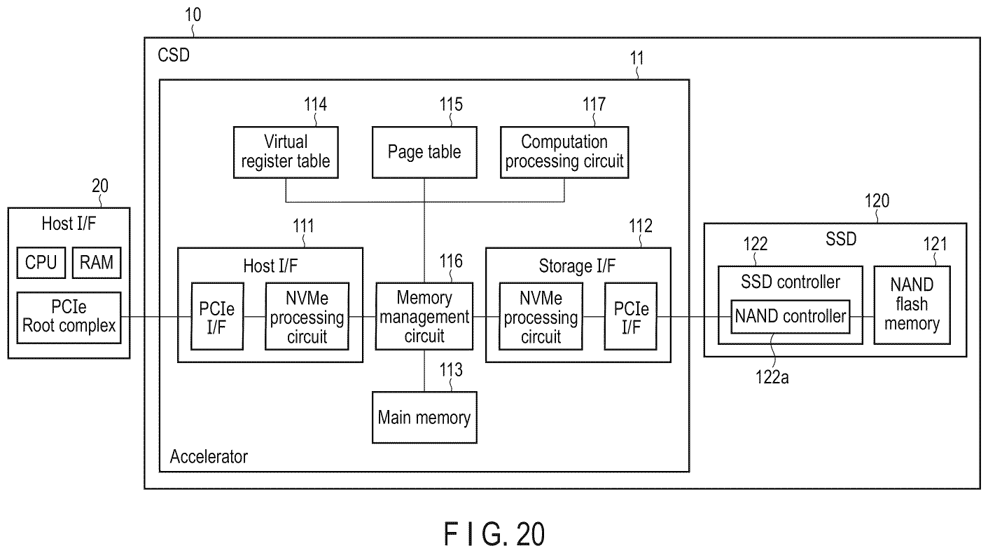

By the way, the storage 12 provided in the CSD 10 in the present embodiment is assumed to be, for example, a Solid State Drive (SSD) 120 including a NAND flash memory 121 as a nonvolatile memory, as shown in FIG. 20. In this case, the CSD 10 is configured to be connectible to the host 20 via, for example, a system bus such as a Peripheral Component Interconnect Express (PCIe) bus. In addition, for example, Non-Volatile Memory Express (NVMe) is adopted as the communication protocol between the CSD 10 and the host 20. In other words, the CSD 10 (host interface 111) is configured to be connectible to (execute communication with) the host 20 based on the NVMe standard. In this case, the host 20 includes a device referred to as Root Complex with a PCIe port in addition to the CPU, RAM, and the like. In addition, the host interface 111 and the storage interface 112 provided in the accelerator 11 include PCIe interfaces (I/F) that execute processing compliant with the PCIe standard and NVMe processing circuits that execute processing compliant with the NVMe standard. In this case, the I/O commands (read and write commands) described in the present embodiment correspond to the commands (NVMeRead and NVMeWrite commands) compliant with the NVMe standard. In addition, the host data described in the present embodiment and the metadata attached to the host data correspond to NVMe data and NVMe metadata.

The SSD 120 includes an SSD controller 122 that controls the NAND flash memory 121 in addition to the NAND flash memory 121. The SSD controller 122 includes a NAND controller 122a that commands read operations and write operations to the NAND flash memory 121 via the NAND interface, based on requests received from the storage interface 112. The NAND controller 122a also commands read operations, write operations, erase operations, and the like to the NAND flash memory 121 via the NAND interface in background processing, regardless of the requests received via the storage interface 112. In addition, the NAND controller 122a manages the data storage area in the NAND flash memory 121 as a physical address, and maps logical addresses to physical addresses by using an address translation table.

Incidentally, it is assumed that the SSD controller 122 is arranged inside the SSD 120 (i.e., the accelerator 11 is arranged outside the SSD controller 122) in FIG. 20, but the accelerator 11 of the present embodiment may also be arranged inside the SSD controller 122.

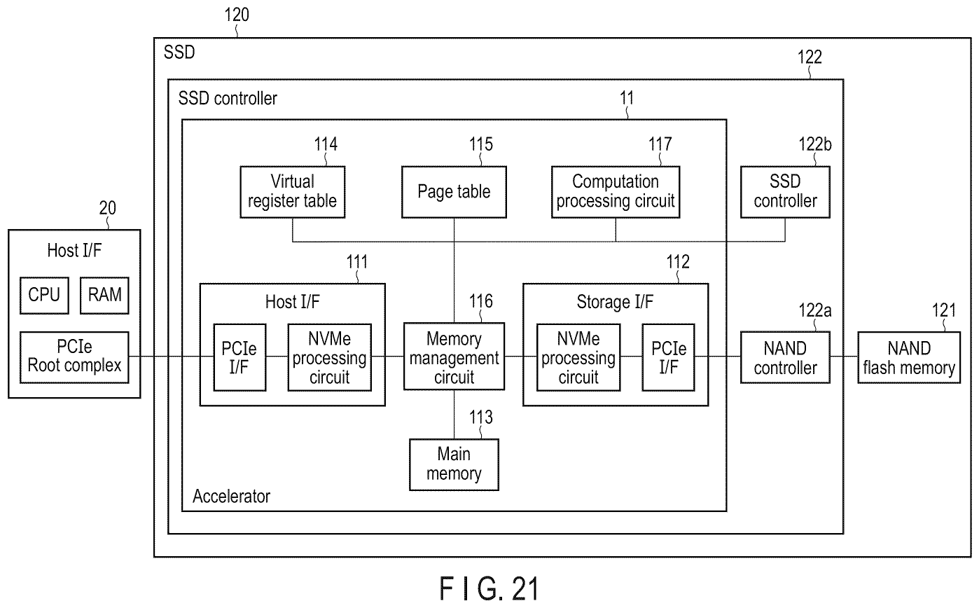

FIG. 21 shows an example of a configuration in which the accelerator 11 is arranged inside the SSD controller 122. According to the example shown in FIG. 21, the SSD 120 includes a NAND flash memory 121 and an SSD controller 122. The SSD controller 122 includes an accelerator 11 and an SSD controller 122b in addition to the NAND controller 122a. It is assumed that the NAND controller 122a and the SSD control section 122b are realized by, for example, hardware, but at least several parts of the entire NAND control section 122a and SSD control section 122b may be realized by a processor provided in the SSD controller 122, which executes a predetermined program (i.e., software). The SSD controller 122b has the function of controlling the operation of the SSD 120. The SSD 120 shown in the example shown in FIG. 21 may correspond to the CSD 10 described in the present embodiment. In addition, in the configuration shown in FIG. 21, the SSD 120 may be referred to as a memory system, and the SSD controller 122 may be referred to as a memory controller.

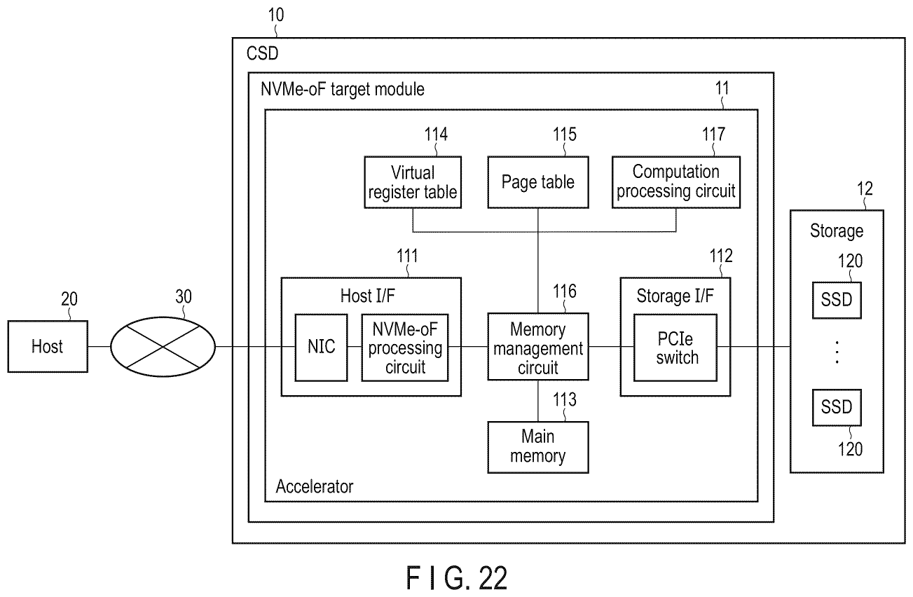

Furthermore, as shown in FIG. 22, the CSD 10 may be configured to be connectible to the host 20 via the network 30. In this case, for example, NVMe-OF (NVMe over Fabric) is used as the communication protocol between the CSD 10 and the host 20, and the accelerator 11 is arranged inside an NVMe-oF target module of the CSD 10. In other words, the accelerator 11 is configured to be connectible to the host 20 via the network 30 in conformity with the NVMe-OF standard. Incidentally, in the example shown in FIG. 22, the host interface 111 provided in the accelerator 11 includes a Network Interface Card (NIC) and an NVMe-OF processing circuit that executes the processing according to the NVMe-oF standard. In addition, in the example shown in FIG. 22, the storage 12 includes plural SSD 120, and the storage interface 112 includes PCIe switches that execute switching for the plural SSD 120.

Incidentally, since FIG. 20 to FIG. 22 are prepared to illustrate the application example of the accelerator 11 of the present embodiment, the configurations shown in FIG. 20 to FIG. 22 may be changed as needed.

In addition, it has been described that the accelerator 11 (controller) and the storage 12 form a single device (computing storage device) in the present embodiment, but the controller and the storage may be configured to be arranged as separate devices.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A controller configured to control a computing storage device including a storage connectible to a host, the controller comprising:
a first interface configured to receive an I/O command specifying first host data from the host;
a second interface configured to transmit and receive the first host data to and from the storage; and
a computation processing circuit, wherein
the computation processing circuit includes:
an input circuit configured to input the first host data and plural computation parameters;
a duplication processing circuit configured to duplicate the first host data to obtain plural first host data;
plural first processing circuits configured to execute in parallel computation processes using the input plural parameters for the obtained plural first host data; and
an output circuit configured to output a computation processing result in each of the plural first processing circuits.

2. The controller of claim 1, wherein
the first host data includes a cipher text of fully homomorphic encryption,
plural computation parameters include key-switching keys different from each other, and
each of the plural first processing circuits is configured to execute a key-switching process using a key-switching key corresponding to the first processing circuit.

3. The controller of claim 2, further comprising:
a second processing circuit, wherein
the input circuit is further configured to input a bootstrapping key to be used for a bootstrapping process,
the second processing circuit is configured to execute a bootstrapping process for the cipher text of the fully homomorphic encryption, using the input bootstrapping key,
the duplication processing circuit is configured to obtain results of plural bootstrapping processes by duplicating results of the bootstrapping processes, and
each of the plural first processing circuits is configured to execute a key-switching process using a key-switching key corresponding to the first processing circuit, for the results of the plural bootstrapping processes.

4. The controller of claim 3, wherein
the second processing circuit is configured to execute homomorphic computation for the cipher text of the fully homomorphic encryption, and execute the bootstrapping process for the result of the homomorphic computation.

5. The controller of claim 1, wherein
the first interface is connectible with the host based on NVMe standard, and
the I/O command is a command conforming to the NVMe standard.

6. The controller of claim 5, wherein
the computation process is executed in accordance with a computation option attached to the I/O command, and
the computation option is included in metadata added to the first host data.

7. The controller of claim 1, wherein
the storage is a nonvolatile memory, and
the controller is connected to the nonvolatile memory and is configured to control the nonvolatile memory.

8. The controller of claim 7, wherein
the computing storage device is a solid state drive (SSD).

9. The controller of claim 1, wherein
the controller is connectible with the host via a network in conformity with NVMe-OF standard.

10. The controller of claim 9, wherein
the computing storage device comprises an NVMe-OF target module, and
the controller is arranged in the NVMe-OF target module.

11. A memory system connectible to a host, comprising:
a storage; and
a controller configured to control the memory device, wherein
the controller includes:
a first interface configured to receive an I/O command specifying first host data from the host;
a second interface configured to transmit and receive the first host data to and from the storage; and
a computation processing circuit, and
the computation processing circuit includes:
an input circuit configured to input the first host data and plural computation parameters;
a duplication processing circuit configured to duplicate the first host data to obtain plural first host data;
plural first processing circuits configured to execute in parallel computation processes using the input plural parameters for the obtained plural first host data; and
an output circuit configured to output a computation processing result in each of the plural first processing circuits.

12. The memory system of claim 11, wherein
the first host data includes a cipher text of fully homomorphic encryption,
plural computation parameters include key-switching keys different from each other, and
each of the plural first processing circuits is configured to execute a key-switching process using a key-switching key corresponding to the first processing circuit.

13. The memory system of claim 12, wherein
the controller further includes a second processing circuit,
the input circuit is further configured to input a bootstrapping key to be used for a bootstrapping process,
the second processing circuit is configured to execute a bootstrapping process for the cipher text of the fully homomorphic encryption, using the input bootstrapping key,
the duplication processing circuit is configured to obtain results of plural bootstrapping processes by duplicating results of the bootstrapping processes, and
each of the plural first processing circuits is configured to execute a key-switching process using a key-switching key corresponding to the first processing circuit, for the results of the plural bootstrapping processes.

14. The memory system of claim 13, wherein
the second processing circuit is configured to execute homomorphic computation for the cipher text of the fully homomorphic encryption, and execute the bootstrapping process for the result of the homomorphic computation.

15. The memory system of claim 11, wherein
the first interface is connectible with the host based on NVMe standard, and
the I/O command is a command conforming to the NVMe standard.

16. The memory system of claim 15, wherein
the computation process is executed in accordance with a computation option attached to the I/O command, and
the computation option is included in metadata added to the first host data.

17. The memory system of claim 11, wherein
the storage is a nonvolatile memory, and
the controller is connected to the nonvolatile memory and is configured to control the nonvolatile memory.

18. The memory system of claim 17, wherein
the memory system is a solid state drive (SSD).

19. The memory system of claim 11, wherein
the controller is connectible with the host via a network, in conformity with NVMe-OF standard.

20. The memory system of claim 19, further comprising:
an NVMe-oF target module, wherein
the controller is arranged in the NVMe-OF target module.
